(19) United States
(12) Patent Application Publication
(10) Pub. No.: US 2014/0232730 A1
(43) Pub. Date: Aug. 21, 2014

(54) INFORMATION ACQUISITION/PRESENTATION APPARATUS, INFORMATION PROVIDING APPARATUS, AND INFORMATION COMMUNICATION SYSTEM PROVIDED WITH INFORMATION ACQUISITION/PRESENTATION APPARATUS AND INFORMATION PROVIDING APPARATUS

(71) Applicant: Kentaro Asai, Toyota-shi (JP)

(72) Inventor: Kentaro Asai, Toyota-shi (JP)

(73) Assignee: TOYOTA JIDOSHA KABUSHIKI KAISHA, Toyota-shi, Aichi (JP)

(21) Appl. No.: 14/240,551

(22) PCT Filed: Aug. 30, 2011
(86) PCT No.: PCT/JP2011/069601

§ 371 Date: Feb. 24, 2014

(51) Int. Cl. G09G 5/00

(52) U.S. Cl. CPC G09G 5/005
USPC 345/522

(57) ABSTRACT

Based on whether a display region of a display for displaying information provided from an information providing center is large or small, in a state in which a display area is small (display pixel is small or number of characters that can be displayed in character array direction is small), an information presentation ECU requests the information providing center to provide mobile-ready information to be displayed in the state in which the display area is small by access in a mobile user agent. Meanwhile, in a state in which the display area is large (display pixel is large or number of characters that can be displayed in character array direction is large), the information presentation ECU requests the information providing center to provide PC-ready information to be displayed in the state in which the display area is large by access in a PC user agent.

### TECHNICAL FIELD

The present invention relates to an information acquisition/presentation apparatus for acquiring information supplied from an external portion and presenting the information, an information providing apparatus for providing information to an external portion, and an information communication system provided with an information acquisition/presentation apparatus and an information providing apparatus.

### BACKGROUND ART

Up to now, for example, there are known such an access support method to an event, an event management system, and a computer program as disclosed in the following Patent Literature 1. In those related-art access support method to the event, event management system, and computer program, each time a user views a Web page on a PC, the PC causes a management server to accumulate user event data based on a URN of the Web page viewed by the user in time series. The management server transmits an event list to a cellular phone in response to a request received from the cellular phone. The cellular phone, which has received the event list, transmits the user event data designated by the user from the event list and terminal data for identifying a terminal to the management server, while the management server transmits the Web page corresponding to the event data to the cellular phone by converting the Web page into display data for the cellular phone. With this configuration, it is easy to again view electronic information, which has been viewed once on a network, without depending on the terminal or a data format.

Further, up to now, for example, there is known such an information display device as disclosed in the following Patent Literature 2. This related-art information display device includes: data communication means for receiving display data through a communication network; storage means for saving a program and the display data; input means for receiving an event input accompanying each operation; control means for executing the program in response to the event input; and display means for processing the display data and performing display on a screen, and in the related-art information display device: the display means includes image processing means; and the image processing means performs processing for pasting the display data on a 3D object as a texture by using a file defining a motion of the 3D object when displaying demonstration of an advertisement. With this configuration, the advertisement can be provided in harmony with a screen when application software is being executed on the information display device such as a cellular phone or a smartphone whose screen has a limited size.

Further, up to now, for example, there are known such an information processing device and a control program therefor as disclosed in the following Patent Literature 3. In those related-art information processing device and control program therefor, when Web content is to be expanded and displayed into a Web page, the Web content received by the information processing device is analyzed to extract columns serving as component units in terms of a layout of the Web page. Then, in a display state of the Web page by a display device, it is determined whether or not a display area of each of the columns displayed within a display range is a sufficient display area in comparison with a threshold value, and when the display area of the column is not a sufficient display area as a result of the determination, contents of the column are displayed after being adapted to a display form for preview in accordance with the display area such as after having highly-emphasized text summarized preferentially. With this configuration, a summary of the contents of the column of the Web content can be grasped on the information processing device such as a mobile terminal having a small screen with a reduced number of complicated operations.

In addition, up to now, for example, there is known such a display device as disclosed in the following Patent Literature 4. This related-art display device includes: mounting means for detachably mounting a mobile terminal; display panel control means for causing a display panel to operate in a mobile terminal mode for displaying information stored in the mobile terminal mounted to the mounting means and a normal mode for displaying a screen to which a state of a device main body and an instruction for the device main body can be input; mounting detection means for detecting that the mobile terminal is mounted to the mounting means; and mode switching means for switching a display mode, in which the display panel control means causes the display panel to operate, to the mobile terminal mode when it is detected that the mobile terminal is mounted. With this configuration, even the screen of a cellular phone having a small size or a low resolution allows an image having a large size to be viewed satisfactorily.

### CITATION LIST

### Patent Literature

### [PTL 1] JP 2006-285764 A

### [PTL 2] JP 2011-103073 A

### [PTL 3] JP 2011-22914 A

### [PTL 4] JP 2006-72514 A

### SUMMARY OF INVENTION

In the above-mentioned related-art devices, methods, and programs, for example, when information is to be displayed on a display panel (display) having a small screen size, the information is converted into information reduced in accordance with the screen size or changed so as to fall within a page by changing an array of characters. In this case, when display contents are simply reduced, there may occur a situation in which the characters being displayed are too battered to read or in which an image is distorted. Further, when the array of the characters is simply changed, it is highly probable that a page layout may be broken, and it may become difficult to read the information being displayed. On the other hand, when information adapted to a small screen size is displayed on the display panel having a large screen size, for example, a number of displayed characters may be wastefully displayed with a large number of margins.

The present invention has been made in view of the above-mentioned problems, and one of objects thereof is to provide an information acquisition/presentation apparatus capable of acquiring and providing information based on a display mode corresponding to a display state on a display, an information providing apparatus, and an information communication system provided with an information acquisition/presentation apparatus and an information providing apparatus.

In order to attain the above-mentioned object, according to a feature of the present invention, there is provided an information acquisition/presentation apparatus, including: communication means for communicating to/from an external portion; information acquisition means for acquiring information provided from the external portion through the communication means; and information presentation means including a display for displaying the information acquired by the information acquisition means, in which the information presentation means switches the information to be displayed between the information in one display mode acquired by the information acquisition means and the information in another display mode different from the one display mode acquired by the information acquisition means depending on an information display state on the display.

In this case, the information presentation means may issue one information providing request signal for requesting the external portion to provide the information to be displayed in the one display mode or another information providing request signal for requesting the external portion to provide the information to be displayed in the another display mode, which is different from the one information providing request signal, through the communication means depending on the information display state on the display, display the information to be displayed in the one display mode, which has been acquired in correspondence with the one information providing request signal from the external portion by the information acquisition means, on the display, and display the information to be displayed in the another display mode, which has been acquired in correspondence with the another information providing request signal from the external portion by the information acquisition means, on the display.

Further, according to another feature of the present invention, there is provided an information providing apparatus, including: communication means for communicating to/from an external portion; request acquisition means for acquiring a request relating to provision of information from the external portion; and information providing means for supplying and providing, through the communication means, the information corresponding to the request acquired by the request acquisition means through the communication means, the information providing means including storage means for storing various kinds of information, in which the information providing means provides the external portion with the information to be displayed in one display mode or the information to be displayed in another display mode different from the one display mode.

In this case, the information providing means may provide the external portion with the information corresponding to one information providing request signal for requesting to provide the information to be displayed in the one display mode, which is issued from the external portion based on an information display state on a display provided to the external portion, when the request acquisition means acquires the one information providing request signal, and the information providing means may provide the external portion with the information corresponding to another information providing request signal for requesting to provide the information to be displayed in the another display mode, which is different from the one information providing request signal and is issued from the external portion based on the information display state on the display provided to the external portion, when the request acquisition means acquires the another information providing request signal.

Further, according to another feature of the present invention, there is provided an information communication system, including an information providing apparatus for providing various kinds of information and an information acquisition/presentation apparatus for acquiring the various kinds of information provided from the information providing apparatus and presenting the various kinds of information, which communicate to/from each other, in which: the information acquisition/presentation apparatus issues one information providing request signal for requesting the information providing apparatus to provide the information to be displayed in one display mode or another information providing request signal for requesting the information providing apparatus to provide the information to be displayed in another display mode different from the one display mode, which is different from the one information providing request signal, depending on an information display state on a display for displaying the acquired information; the information providing apparatus provides the information acquisition/presentation apparatus with the information to be displayed in the one display mode corresponding to the one information providing request signal when acquiring the one information providing request signal issued from the information acquisition/presentation apparatus, and provides the information acquisition/presentation apparatus with the information to be displayed in the another display mode corresponding to the another information providing request signal when acquiring the another information providing request signal issued from the information acquisition/presentation apparatus; and the information acquisition/presentation apparatus displays the information to be displayed in the one display mode, which has been acquired in correspondence with the one information providing request signal from the information providing apparatus, on the display, and displays the information to be displayed in the another display mode, which has been acquired in correspondence with the another information providing request signal from the information providing apparatus, on the display.

In those cases, the one display mode may be any one selected from the group consisting of: a display mode in which a display area for displaying the information on the display is large; a display mode in which a display pixel for displaying the information on the display is large; and a display mode in which a number of characters that are displayable on the display in a character array direction of the information is large, and the another display mode may be any one selected from the group consisting of: a display mode in which the display area for displaying the information on the display is small; a display mode in which the display pixel for displaying the information on the display is small; and a display mode in which the number of characters that are displayable on the display in the character array direction of the information is small.

In this case, the display mode of the another display mode in which the display area for displaying the information on the display is small may be a display mode in which a plurality of kinds of information are simultaneously displayed on the display. Further, in this case, the plurality of kinds of information may include at least navigation information for showing a route to a destination set by a user.

According thereto, depending on the information display state on the display for displaying the acquired information, the information acquisition/presentation apparatus can issue the one information providing request signal for requesting the information providing apparatus to provide the information to be displayed in the one display mode or the another information providing request signal, which is different from the one information providing request signal, for requesting the information providing apparatus to provide the information to be displayed in the another display mode different from the one displayed mode. The information providing apparatus can provide, when acquiring the one information providing request signal issued from the information acquisition/presentation apparatus, the information acquisition/presentation apparatus with the information to be displayed in the one display mode corresponding to the one information providing request signal, and can provide, when acquiring the another information providing request signal issued from the information acquisition/presentation apparatus, the information acquisition/presentation apparatus with the information to be displayed in the another display mode corresponding to the another information providing request signal. Then, the information acquisition/presentation apparatus can display the information to be displayed in the one display mode, which has been acquired in correspondence with the one information providing request signal from the information providing apparatus, on the display, and can display the information to be displayed in the another display mode, which has been acquired in correspondence with the another information providing request signal from the information providing apparatus, on the display, that is, can display and present the information by switching between the one display mode and the another display mode.

The one display mode may be any one selected from the group consisting of: the display mode in which the display area for displaying the information on the display is large; the display mode in which the display pixel for displaying the information on the display is large; and the display mode in which the number of characters that are displayable on the display in the character array direction of the information is large, and the another display mode may be any one selected from the group consisting of: the display mode in which the display area for displaying the information on the display is small; the display mode in which the display pixel for displaying the information on the display is small; and the display mode in which the number of characters that are displayable on the display in the character array direction of the information is small.

With this configuration, in a state in which the display area is large (the display pixel is large or the number of characters that are displayable in the character array direction is large), the information acquisition/presentation apparatus can issue the one information providing request signal for making a request to provide the information to be displayed in the one display mode suitable for display in the state in which the display area is large, to thereby make the request of the information providing apparatus (external portion). On the other hand, based on whether a display region of the display is large or small, in a state in which the display area is small (the display pixel is small or the number of characters that are displayable in the character array direction is small), the information acquisition/presentation apparatus can issue the another information providing request signal for making a request to provide the information to be displayed in the another display mode suitable for display in the state in which the display area is small, to thereby make the request of the information providing apparatus (external portion). Therefore, the information acquisition/presentation apparatus can acquire the information suitable for the current display state from the information providing apparatus (external portion) and display the information on the display.

With this configuration, the information to be presented to the user can be presented with extremely satisfactory visibility ensured at all times without breaking a page layout due to, for example, a batter of a character or a distortion of an image. Accordingly, the user can view the presented information with extreme ease.

### BRIEF DESCRIPTION OF DRAWINGS

FIG. 1 is a schematic diagram of an information communication system provided with an information acquisition/presentation apparatus mounted to a vehicle and an information providing apparatus (including external content provider), according to an embodiment of the present invention.

FIG. 2 is a flowchart for illustrating a flow of information exchanged by an information presentation ECU of the information acquisition/presentation apparatus and a server of an information providing center, which are illustrated in FIG. 1, according to the embodiment of the present invention.

FIG. 3 is a diagram for illustrating a display mode of mobile-ready information acquired by access in a mobile user agent, according to the embodiment of the present invention.

FIG. 4 is a diagram for illustrating a display mode of PC-ready information acquired by access in a PC user agent, according to the embodiment of the present invention.

FIG. 5 is a schematic diagram of the information communication system provided with an information acquisition/presentation apparatus serving as an information terminal and an information providing apparatus (including external content provider), according to a modified example of the present invention.

FIG. 6 is a flowchart for illustrating a flow of information exchanged by a main control section of the information terminal and the server of the information providing center, which are illustrated in FIG. 5, according to the modified example of the present invention.

FIG. 7 is a diagram for illustrating the display mode of the mobile-ready information acquired by the access in the mobile user agent on the information terminal, according to the modified example of the present invention.

FIG. 8 is a diagram for illustrating the display mode of the PC-ready information acquired by the access in the PC user agent on the information terminal, according to the modified example of the present invention.

### DESCRIPTION OF EMBODIMENT

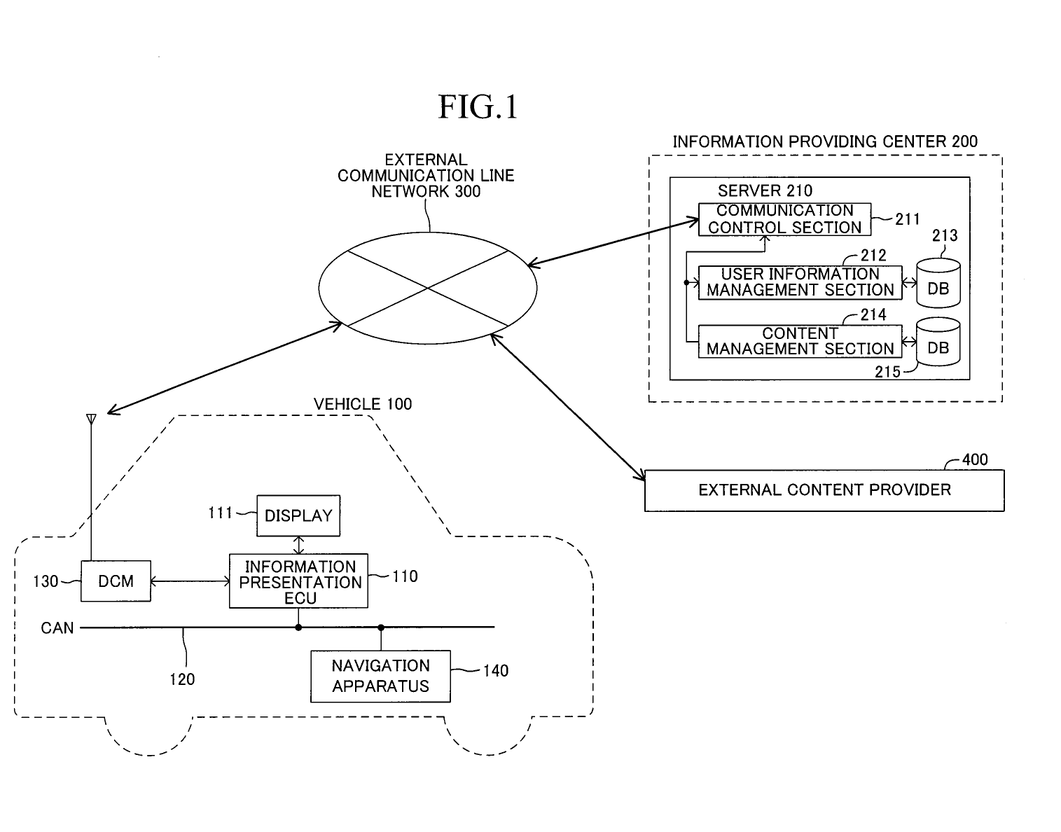

Now, a description is made of an information acquisition/presentation apparatus and an information providing apparatus according to an embodiment of the present invention with reference to the accompanying drawings. FIG. 1 is a schematic block diagram schematically illustrating an information communication system including the information acquisition/presentation apparatus and the information providing apparatus according to this embodiment.

First, the information communication system for a vehicle is described. The information communication system for a vehicle according to this embodiment includes a vehicle 100 including the information acquisition/presentation apparatus, an information providing center 200 including the information providing apparatus, and an external content provider 400, which are organically coupled to one another through an external communication line network 300 (for example, the Internet or dedicated line network) to be able to provide a user with various services and various kinds of information. Here, the external content provider 400 is provided with a server including a microcomputer as a main component, and provides various kinds of content (PC-ready information content or mobile-ready content described later) to the vehicle 100 and the information providing center 200 through the external communication line network 300.

The vehicle 100 is provided with an information presentation ECU 110 serving as information presentation means for acquiring various kinds of information (for example, various kinds of search result information) provided from the information providing center 200, displaying the acquired various kinds of information based on a display state of information (specifically, navigation information described later) relating to traveling of the vehicle 100, and presenting the various kinds of information to the user. The information presentation ECU 110 includes a microcomputer as a main component formed of a CPU, a ROM, a RAM, and the like, and is provided with a nonvolatile memory and an input/output interface. Further, a display 111 is connected to the information presentation ECU 110 through the input/output interface. The display 111 is, for example, a touch-panel liquid crystal display, and is located in the vicinity of a driver's seat of the vehicle 100. Further, the information presentation ECU 110 is connected to a CAN communication line 120 of a controller area network (CAN) communication system, and is allowed to input/output various signals and various kinds of information to/from another device (for example, navigation device 140 described later) via the CAN communication line 120.

Further, a data communication module 130 (hereinafter referred to as “DCM 130”) serving as communication means and information acquisition means for communicating to/from the information providing center 200 through the external communication line network 300 is connected to the information presentation ECU 110. The DCM 130 performs data communications to/from a server 210 of the information providing center 200 described later through the external communication line network 300. For example, the DCM 130 performs data communications to/from the information presentation ECU 110 through a USB connection, acquires an information providing request signal described later issued from the information presentation ECU 110, and transmits the information providing request signal to the information providing center 200. Further, the DCM 130 receives and acquires the various kinds of information provided from the information providing center 200, and outputs the various kinds of information to the information presentation ECU 110. Note that, in this embodiment, the present invention is carried out by providing the information presentation ECU 110 and the DCM 130 as separate components (that is, independently of each other), but it should be understood that the present invention can be carried out by providing the information presentation ECU 110 and the DCM 130 integrally with each other. Further, in this embodiment, the present invention is carried out by providing the DCM 130 as the information acquisition means. However, the present invention is not limited thereto as the information acquisition means, and it is possible to use, for example, any means that can be used for communications to/from the information providing center 200 and the external content provider 400 by being connected to the external communication line network 300 such as Wi-Fi (trademark), a cellular phone (including smartphone) owned by a user, or tethering.

In addition, the navigation device 140 for searching for a route to a destination set by the user (driver) and showing the retrieved route is connected to the CAN communication line 120. Note that, a configuration of the navigation device 140 and an operation thereof do not directly relate to the present invention, and the known configuration and operation can be employed. A brief description thereof is made below. The navigation device 140 is provided with: a vehicle position detection unit (not shown) including a GPS device for detecting current position coordinates of the vehicle 100 based on a radio wave received from a GPS satellite to detect a current position and a traveling direction of the vehicle 100; a memory (not shown) for storing various kinds of information such as map data; an electronic control unit (not shown) for executing a program for guiding the vehicle 100 to the destination; a human interface (not shown) formed of the display 111 and a speaker; and the like.

Here, when the information presentation ECU 110 and the electronic control unit of the navigation device 140 display their respective pieces of information on the display 111 shared thereby, the information presentation ECU 110 can use an entire display region on the display 111 if the user (driver) is not currently using the navigation device 140, for example. That is, this case corresponds to a case where a display area of the information displayed on the display 111 is large, a case where a display pixel of the information displayed on the display 111 is large, or a case where a number of characters that can be displayed on the display 111 in a character array direction of the displayed information is large, and hence the information presentation ECU 110 displays and presents the information provided from the information providing center 200 in one display mode. Note that, in the following description, the information provided from the information providing center 200 and displayed on the display 111 in the one display mode by the information presentation ECU 110 is referred to as “PC-ready information”.

On the other hand, when the user (driver) is currently using the navigation device 140, the information presentation ECU 110 and the electronic control unit of the navigation device 140 display their respective pieces of information within display regions obtained by evenly dividing the display region of the display 111. Specifically, the information presentation ECU 110 can use only a half of the display region of the display 111 because the guide route is displayed by the navigation device 140 in the other half of the display region of the display 111.

That is, this case corresponds to a case where the display area of the information displayed on the display 111 is small, a case where the display pixel of the information displayed on the display 111 is small, or a case where the number of characters that can be displayed on the display 111 in the character array direction of the displayed information is small, and hence the information presentation ECU 110 displays and presents the information provided from the information providing center 200 in another display mode. Note that, in the following description, the information provided from the information providing center 200 and displayed on the display 111 in the another display mode by the information presentation ECU 110 is referred to as “mobile-ready information”.

More specifically, the information presentation ECU 110 can determine whether or not the navigation device 140 needs to display route guidance information relating to route guidance by communicating to/from the electronic control unit of the navigation device 140 through the CAN communication line 120. Then, the information presentation ECU 110 requests the information providing center 200 to provide the PC-ready information or the mobile-ready information based on whether or not the navigation device 140 occupies a part of the display region of the display 111 for displaying the route guidance information, in other words, whether the display region of the display 111 for displaying the information provided from the information providing center 200 is large or small.

That is, when determining that an information display state of the display 111 is a state in which the display region is large because the display 111 is not shared with the navigation device 140, in other words, a state in which the display area is large, the display pixel is large, or the number of characters that can be displayed in the character array direction is large, the information presentation ECU 110 outputs (issues) one information providing request signal to the DCM 130 through the CAN communication line 120 in order to request the information providing center 200 to provide the PC-ready information to be displayed in the one display mode. With this configuration, the DCM 130 transmits the one information providing request signal to the information providing center 200.

On the other hand, when determining that the information display state of the display 111 is a state in which the display region is small because the display 111 is shared with the navigation device 140, in other words, a state in which the display area is small, the display pixel is small, or the number of characters that can be displayed in the character array direction is small, the information presentation ECU 110 outputs (issues) another information providing request signal to the DCM 130 through the CAN communication line 120 in order to request the information providing center 200 to provide the mobile-ready information to be displayed in the another display mode. With this configuration, the DCM 130 transmits the another information providing request signal to the information providing center 200.

The information providing center 200 is a facility for receiving (acquiring), from the vehicle 100 (more specifically, information presentation ECU 110 and DCM 130), the one information providing request signal for requesting to provide the PC-ready information or the another information providing request signal for requesting to provide the mobile-ready information and providing the user of the vehicle 100 with information or the like (for example, search result information) relating to different kinds of services. Therefore, the information providing center 200 is provided with the server 210 including a microcomputer as a main component.

The server 210 is provided with: a communication control section 211 connected to the external communication line network 300 to control communications; a user information management section 212 for managing user information relating to the user and the vehicle 100; a user information storage section 213 (database) for storing a database of the user information; a content management section 214 for managing content to be provided to the user; and a content storage section 215 (database) for storing a database of the content. Here, the server 210 stores association information for associating, for example, a piece of ID information for identifying the vehicle 100 (information corresponding to license number or vehicle identification number, unique number for identifying the DCM 130, or the like) with a piece of ID information for identifying the user (user name, access password, email address, or the like), and is configured to authenticate the user by identifying any one of the pieces of ID information to extract the information identified by the other piece of ID information.

The content management section 214 searches the content storage section 215 based on which of the one information providing request signal (that is, request to provide the PC-ready information) and the another information providing request signal (that is, request to provide the mobile-ready information) is issued from the information presentation ECU 110 on a vehicle 100 side, and manages the information stored in the content storage section 215. The content storage section 215 is a database for storing the PC-ready information and the mobile-ready information in respective predetermined storage locations so as to allow a search thereof.

Here, specific descriptions are made of the PC-ready information and the mobile-ready information. The PC-ready information and the mobile-ready information are pieces of information that are displayed in different display modes but have the same contents. Specifically, the PC-ready information is so-called information for a personal computer (PC) capable of using a large display. That is, the PC-ready information is information assumed to be used on the large display, and in principle, information having a large information amount of text, which is created by freely setting a display layout (font and size of the character to be displayed, the number of characters that can be displayed in the character array direction, and the like) for displaying the large information amount of text within a large display region with high visibility.

On the other hand, the mobile-ready information is so-called information for a mobile information terminal (for example, cellular phone or smartphone) that uses a display having a limited size. That is, in displaying the information on the mobile information terminal, particularly on the cellular phone, operations for enlargement and reduction, movement, and the like of a display screen are complicated, and operations for toggling of display and hide and the like of the information are complicated. Therefore, the mobile-ready information is, in principle, information created by a limited display layout (font and size of the character to be displayed, the number of characters that can be displayed in the character array direction, and the like) such as using a large number of icons or the like while reducing the information amount of text in order to facilitate viewing in a limited display region by eliminating the need for an enlargement/reduction operation or a display/hide operation as much as possible.

Further, the server 210 provides information corresponding to access accompanied by the issuance of the one information providing request signal (hereinafter this access is referred to as “access in a PC user agent”) and access accompanied by the issuance of the another information providing request signal (hereinafter this access is referred to as “access in a mobile user agent”), which are made by the information presentation ECU 110 (and DCM 130) on the vehicle 100 side.

That is, when the access in the PC user agent is now made by the information presentation ECU 110 on the vehicle 100 side through the DCM 130 and the external communication line network 300, the one information providing request signal is issued based on analyses of the access performed by the user information management section 212 and the content management section 214, and hence the server 210 extracts the content of the PC-ready information stored in the content storage section 215. Then, the server 210 supplies and provides the extracted content of the PC-ready information to the vehicle 100 (information presentation ECU 110) through the communication control section 211 and the external communication line network 300.

On the other hand, when the access in the mobile user agent is now made by the information presentation ECU 110 on the vehicle 100 side through the DCM 130 and the external communication line network 300, the another information providing request signal is issued based on the analyses of the access performed by the user information management section 212 and the content management section 214, and hence the server 210 extracts the content of the mobile-ready information stored in the content storage section 215. Then, the server 210 supplies and provides the extracted content of the PC-ready information to the vehicle 100 (information presentation ECU 110) through the communication control section 211 and the external communication line network 300.

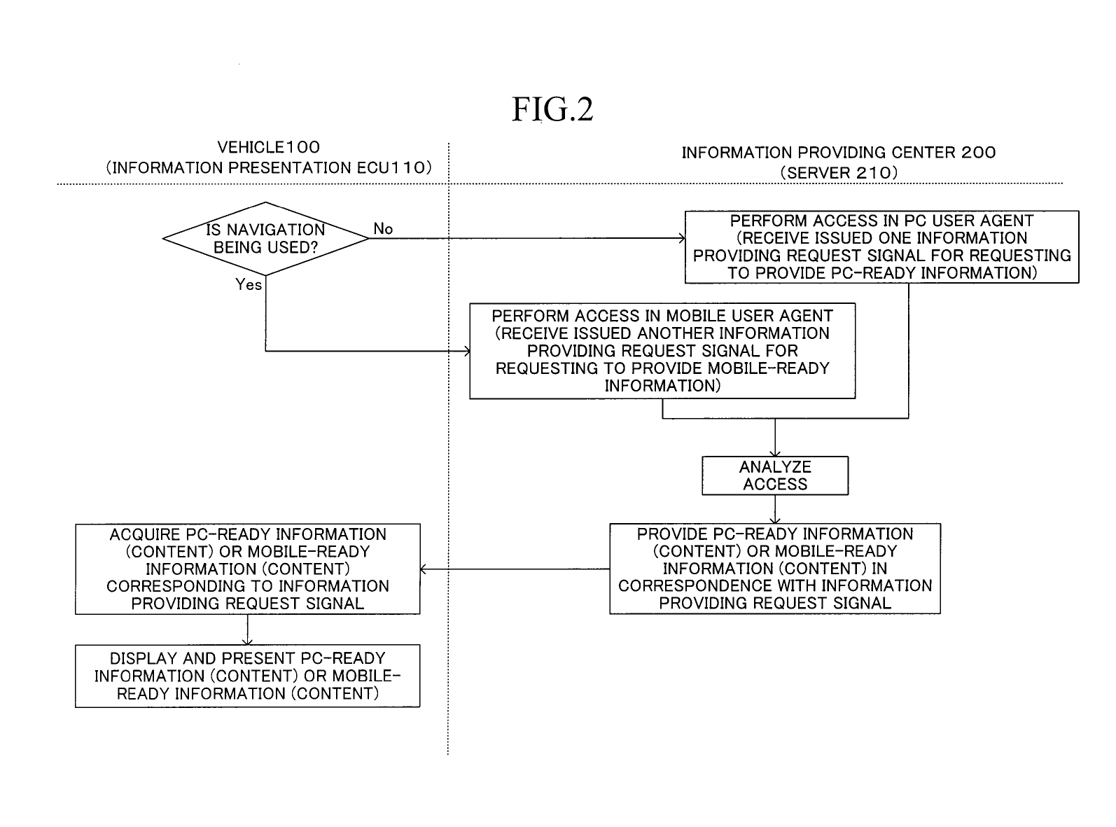

Next, specific descriptions of operations of the information acquisition apparatus and the information providing apparatus according to this embodiment applied to the information communication system having the above-mentioned configuration are made with reference to FIG. 2.

For example, when an ignition switch (not shown) is turned to an on state by the user, as illustrated in FIG. 2, on the vehicle 100 side, the information presentation ECU 110 can communicate to/from the electronic control unit of the navigation device 140 to determine whether or not the navigation device 140 is currently being used by the user and showing the route to the destination set by the user. Further, when the navigation device 140 is currently showing the route to the destination, that is, occupying the part of the display region of the display 111 because of the need to display the route guidance information, the information presentation ECU 110 can access the information providing center 200 in the mobile user agent by using the DCM 130. On the other hand, when the navigation device 140 is not currently showing the route to the destination, that is, when the navigation device 140 is not being used and there is no need to display the route guidance information, the information presentation ECU 110 can access the information providing center 200 in the PC user agent by using the DCM 130.

That is, based on whether the display region of the display 111 for displaying the information provided from the information providing center 200 is large or small, in the state in which the display area is small, the display pixel is small, or the number of characters that can be displayed in the character array direction is small, the information presentation ECU 110 can issue the another information providing request signal by the access in the mobile user agent to request the information providing center 200 to provide the mobile-ready information to be displayed in the another display mode. On the other hand, in the state in which the display area is large, the display pixel is large, or the number of characters that can be displayed in the character array direction is large, the information presentation ECU 110 can issue the one information providing request signal by the access in the PC user agent to request the information providing center 200 to provide the PC-ready information to be displayed in the one display mode.

In the information providing center 200, as illustrated in FIG. 2, the server 210 can receive the one information providing request signal or the another information providing request signal transmitted from the vehicle 100 through the communication control section 211. To describe in more detail, the server 210 can receive the another information providing request signal for requesting to provide the mobile-ready information, which is transmitted by the information presentation ECU 110 on the vehicle 100 side by the access in the mobile user agent, or the one information providing request signal for requesting to provide the PC-ready information, which is transmitted by the information presentation ECU 110 on the vehicle 100 side by the access in the PC user agent.

Further, the server 210 can determine which of the mobile-ready information and the PC-ready information has been requested by using the content management section 214 to analyze the access made by the information presentation ECU 110 on the vehicle 100 side. With this configuration, the server 210 can extract the content of the mobile-ready information stored in the content storage section 215 when the another information providing request signal for requesting to provide the mobile-ready information has been received by the access in the mobile user agent, and can extract the content of the PC-ready information stored in the content storage section 215 when the one information providing request signal for requesting to provide the PC-ready information has been received by the access in the PC user agent.

In this manner, when the content of the mobile-ready information or the content of the PC-ready information is extracted, the server 210 can provide (supply), through the communication control section 211, the extracted content of the mobile-ready information or content of the PC-ready information, in other words, the information requested by the information presentation ECU 110 on the vehicle 100 side by issuing the one information providing request signal or the another information providing signal depending on the information display state of the display 111.

In the vehicle 100, as illustrated in FIG. 2, the information presentation ECU 110 can receive and acquire, through the DCM 130, the content of the mobile-ready information or the content of the PC-ready information provided from the server 210 of the information providing center 200 by using the external communication line network 300. Then, the information presentation ECU 110 can display the acquired content of the mobile-ready information or content of the PC-ready information on the display 111 in accordance with the current information display state.

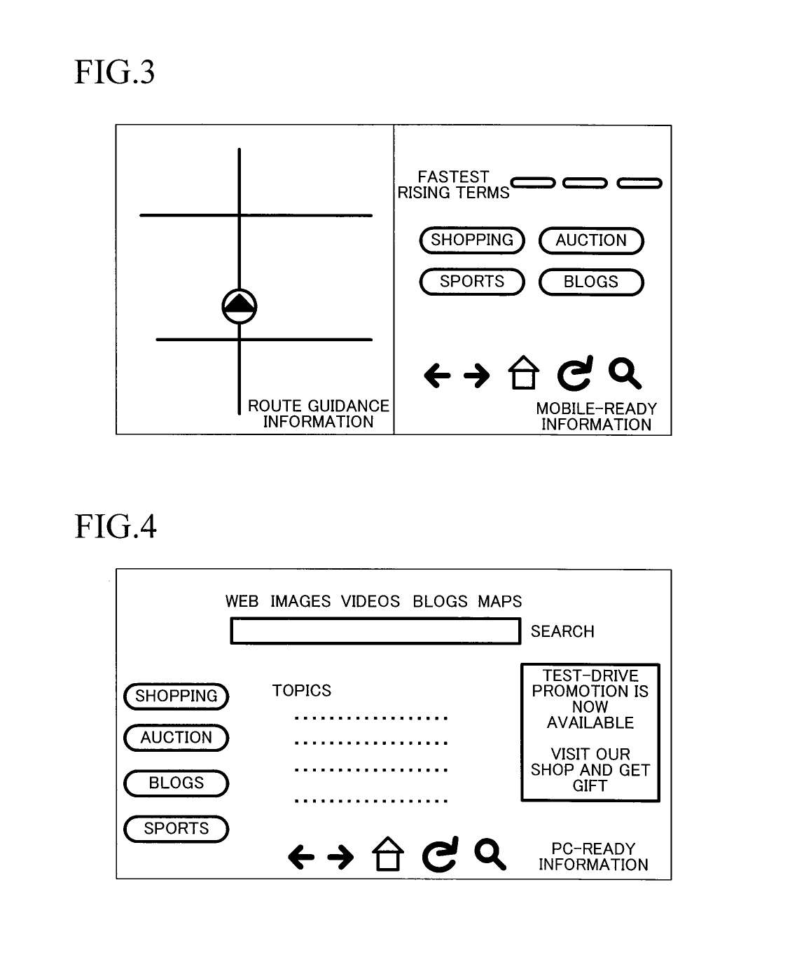

Specifically, as illustrated in FIG. 3, in a situation in which the navigation device 140 is displaying the route guidance information in the display region of the left half of the display 111, the information presentation ECU 110 can display the content of the mobile-ready information in the right half of the display region. Here, the content of the mobile-ready information is originally created by employing a font, a font size, and a display layout that are superior in visibility even in a small display region for a display having a small display region (for example, display of the cellular phone). Accordingly, the content of the mobile-ready information is displayed in the half of the display region on the display 111, to thereby allow the user to view necessary information in an extremely highly visible state.

On the other hand, as illustrated in FIG. 4, in a situation in which the entire display region of the display 111 can be used, the information presentation ECU 110 can display the content of the PC-ready information in the entire display region. Here, the content of the PC-ready information is originally created by freely employing the font, the font size, and the display layout that are superior in visibility on a display having a large display region (for example, display for the PC). Accordingly, the content of the PC-ready information is displayed in the entire display region on the display 111, to thereby allow the user to view necessary information in an extremely highly visible state.

Here, a situation in which, for example, the user cancels the display of the route guidance information in the state in which the route guidance information is currently displayed on the display 111 by the navigation device 140 is assumed. In this situation, the display region on the display 111 becomes large when the display of the route guidance information is canceled, and hence the information presentation ECU 110 issues the one information providing request signal to the information providing center 200, in other words, switches to the access in the PC user agent. With this configuration, in accordance with an increase in size of the display region, the content of the PC-ready information, which is suitable information, can be displayed.

Alternatively, on the other hand, a situation in which, for example, the user requests the display of the route guidance information in the state in which the route guidance information is not currently displayed on the display 111 by the navigation device 140 is assumed. In this situation, the display region on the display 111 becomes small when the display of the route guidance information is requested, and hence the information presentation ECU 110 issues the another information providing request signal to the information providing center 200, in other words, switches to the access in the mobile user agent. With this configuration, in accordance with a decrease in size of the display region, the content of the mobile-ready information, which is suitable information, can be displayed.

As can be understood from the above-mentioned description, according to this embodiment, based on the information display state on the display 111, that is, whether the display region of the display 111 is large or small, in the state in which the display area is small, the display pixel is small, or the number of characters that can be displayed in the character array direction is small, the information presentation ECU 110 of the vehicle 100 can request the information providing center 200 to provide the mobile-ready information to be displayed in the state (another display mode) in which the display region is small by the access in the mobile user agent. On the other hand, in the state in which the display area is large, the display pixel is large, or the number of characters that can be displayed in the character array direction is large, the information presentation ECU 110 can request the information providing center 200 to provide the PC-ready information to be displayed in the state (one display mode) in which the display region is large by the access in the PC user agent. Therefore, the information presentation ECU 110 can acquire the content of the mobile-ready information or the content of the PC-ready information from the information providing center 200, to display and present the information on the display 111.

With this configuration, according to this embodiment, the information to be presented to the user can be presented with extremely satisfactory visibility ensured at all times without breaking a page layout due to a batter of a character, a distortion of an image, or the like. Accordingly, the user can view the presented information with extreme ease.

The description of the above-mentioned embodiment is directed to the situation in which the information presentation ECU 110 simultaneously displays, specifically, a plurality of kinds of information (for example, Internet search information and route guidance information) depending on the information display state on the display 111. That is, when the plurality of kinds of information are simultaneously displayed and presented, each of the display regions on the display 111 becomes small, and hence, the present invention is carried out so that, in order to allow the user to easily view the contents of the information with high visibility even in the small display region, the information presentation ECU 110 accesses the information providing center 200 in the mobile user agent, acquires the content of the mobile-ready information, and displays the content of the mobile-ready information on the display 111. With this configuration, even when the plurality of kinds of information are simultaneously presented, the user can appropriately view the information.

Incidentally, a so-called smartphone, which is widely used in recent years, has a display whose shape is generally a rectangle, and can be used vertically (that is, in such an orientation that the number of characters that can be displayed in the character array direction of the information becomes small) and horizontally (that is, in such an orientation that the number of characters that can be displayed in the character array direction of the information becomes large). In this case, normally, the information has the same layout when displayed vertically and horizontally, and is displayed simply by being enlarged or reduced in order to secure the number of characters that can be displayed vertically and horizontally. Therefore, particularly when the user uses the smartphone vertically, the information is displayed by being reduced, and hence the visibility deteriorates due to, for example, the battered characters.

Therefore, when the user uses the smartphone, in the same manner as in the above-mentioned embodiment, the information necessary for the user can be appropriately displayed by accessing the information providing center 200 in a different user agent depending on whether the smartphone is used vertically or horizontally. A modified example thereof is described below, while like parts as those of the above-mentioned embodiment are denoted by like reference numerals, and descriptions thereof are omitted.

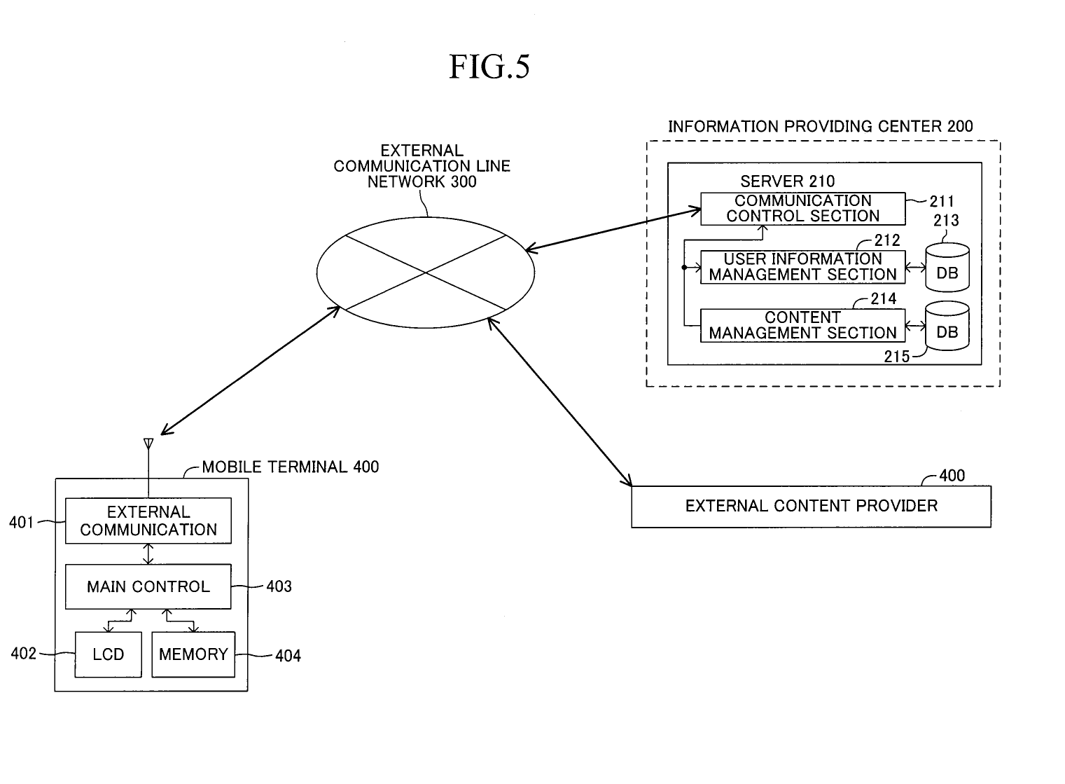

In the modified example, the user owns an information terminal 400 such as a smartphone or a tablet terminal. As illustrated in FIG. 5, the information terminal 400 is configured to acquire various kinds of information (for example, Internet search information) from the information providing center 200 through the external communication line network 300. Therefore, as illustrated in FIG. 5, the information terminal 400 is provided with an external communication control section 401 connected to the external communication line network 300 and serving as information acquisition means for acquiring the various kinds of information from the information providing center 200, a touch-panel liquid crystal display 402 that combines a display and an operation device, a main control section 403 including a microcomputer as a main component and serving as information presentation means for executing display control and various applications, and a nonvolatile memory 404 for storing various kinds of data such as an application program.

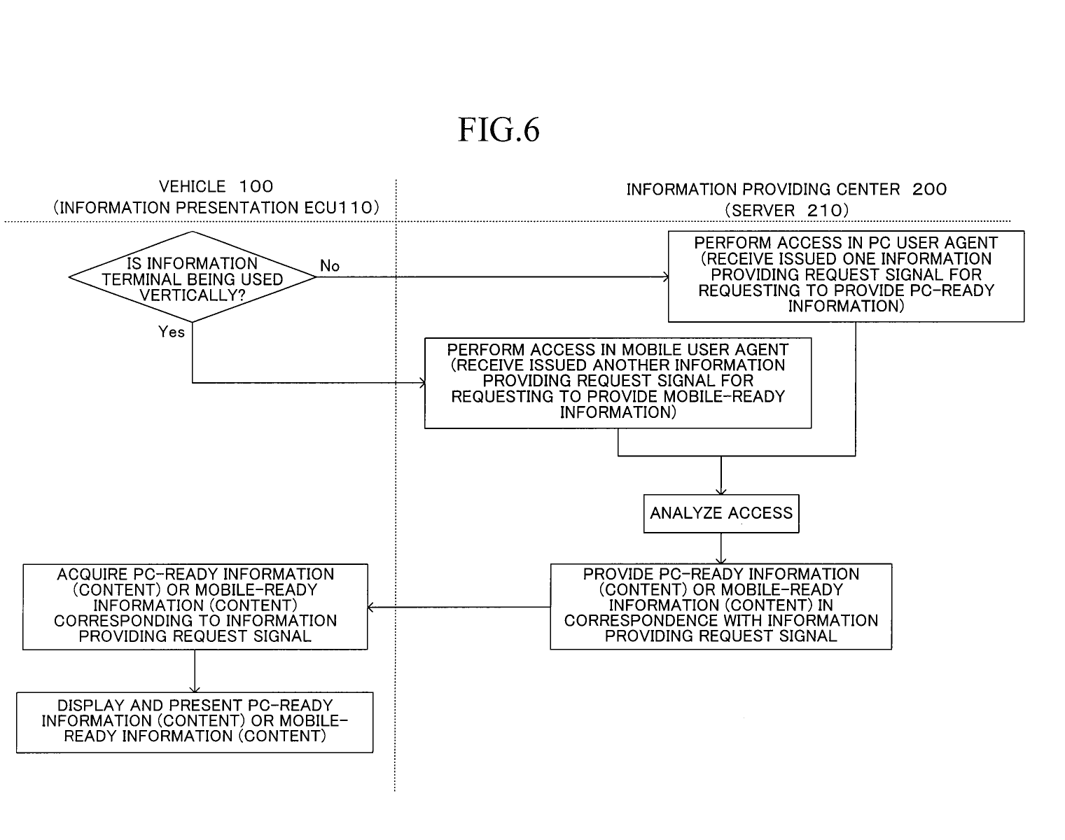

Next, specific descriptions of operations performed in a case of using the information terminal 400 having the above-mentioned configuration are made with reference to FIG. 6.

For example, when the user uses the information terminal 400 to execute a predetermined application, as illustrated in FIG. 6, the main control section 403 on an information terminal 400 side can determine whether or not the information terminal 400 is currently being used vertically by the user by, for example, detecting an acceleration. Further, when the user is currently using the information terminal 400 vertically, that is, the number of characters that can be displayed on the touch-panel liquid crystal display 402 is small due to the vertical use, the main control section 403 can use the external communication control section 401 to access the information providing center 200 in the mobile user agent. On the other hand, when the user is currently using the information terminal 400 horizontally, that is, the number of characters that can be displayed on the touch-panel liquid crystal display 402 is large due to the horizontal use, the main control section 403 can use the external communication control section 401 to access the information providing center 200 in the PC user agent.

That is, based on whether the number of characters that can be displayed on the touch-panel liquid crystal display 402 in the character array direction of the information provided from the information providing center 200 is large or small, in the state in which the number of characters that can be displayed in the character array direction is small, the main control section 403 can request the information providing center 200 to provide the mobile-ready information to be displayed in the state (that is, another display mode) in which the number of characters that can be displayed is small by the access in the mobile user agent. On the other hand, in the state in which the number of characters that can be displayed in the character array direction is large, the main control section 403 can request the information providing center 200 to provide the PC-ready information to be displayed in the state (that is, one display mode) in which the number of characters that can be displayed is large by the access in the PC user agent.

In the information providing center 200, as illustrated in FIG. 6, the server 210 can receive the one information providing request signal or the another information providing request signal transmitted from the information terminal 400 through the communication control section 211. To describe in more detail, the server 210 can receive the another information providing request signal for requesting to provide the mobile-ready information, which is transmitted by the main control section 403 on the information terminal 400 side by the access in the mobile user agent, or the one information providing request signal for requesting to provide the PC-ready information, which is transmitted by the main control section 403 on the information terminal 400 side by the access in the PC user agent.

Further, the server 210 can determine which of the mobile-ready information and the PC-ready information has been requested by using the content management section 214 to analyze the access made by the main control section 403 on the information terminal 400 side. With this configuration, the server 210 can extract the content of the mobile-ready information stored in the content storage section 215 when the another information providing request signal for requesting to provide the mobile-ready information has been received, and can extract the content of the PC-ready information stored in the content storage section 215 when the one information providing request signal for requesting to provide the PC-ready information has been received.

In this manner, when the content of the mobile-ready information or the content of the PC-ready information is extracted, the server 210 can provide (supply), through the communication control section 211, the extracted content of the mobile-ready information or content of the PC-ready information, in other words, the information requested by the main control section 403 on the information terminal 400 side by issuing the one information providing request signal or the another information providing request signal depending on the information display state of the touch-panel liquid crystal display 402 (whether the number of characters that can be displayed is large or small depending on whether the touch-panel liquid crystal display 402 is used vertically or horizontally).

In the information terminal 400, as illustrated in FIG. 6, the main control section 403 can receive and acquire, through the external communication control section 401, the content of the mobile-ready information or the content of the PC-ready information provided from the server 210 of the information providing center 200 by using the external communication line network 300. Then, the main control section 403 can display the acquired content of the mobile-ready information or content of the PC-ready information on the touch-panel liquid crystal display 402 in accordance with the current information display state.

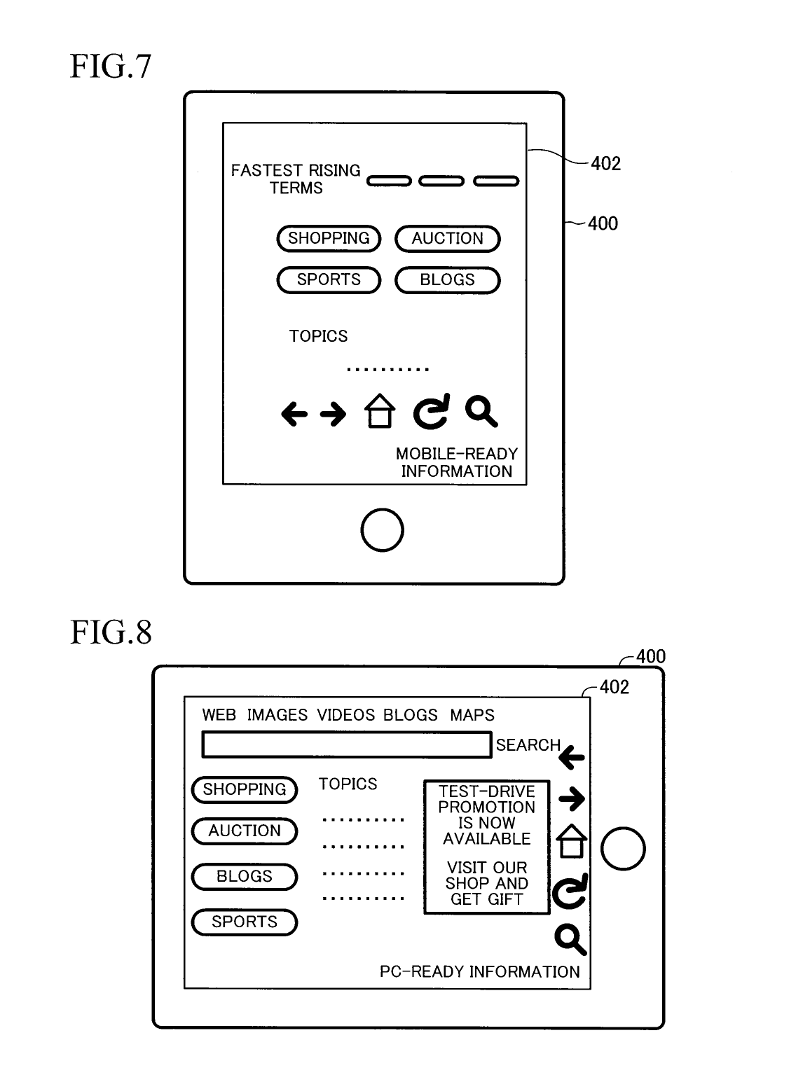

Specifically, as illustrated in FIG. 7, in the situation in which the user is using the information terminal 400 vertically, the main control section 403 can display the content of the mobile-ready information on the touch-panel liquid crystal display 402 used vertically. Here, the content of the mobile-ready information is originally created by employing the font, the font size, and the display layout that are superior in visibility even in the small display region for a display having′ a small number of characters that can be displayed (for example, display of the cellular phone). Accordingly, the content of the mobile-ready information is displayed on the touch-panel liquid crystal display 402 based on the vertical use, to thereby allow the user to view necessary information in an extremely highly visible state.

On the other hand, as illustrated in FIG. 8, in the situation in which the user is using the information terminal 400 horizontally, the main control section 403 can display the content of the PC-ready information on the touch-panel liquid crystal display 402 used horizontally. Here, the content of the PC-ready information is originally created by freely employing the font, the font size, and the display layout that are superior in visibility on a display having a large number of characters that can be displayed (for example, display for PC). Accordingly, the content of the PC-ready information is displayed on the touch-panel liquid crystal display 402, to thereby allow the user to view necessary information in an extremely highly visible state.

As can be understood from the above-mentioned description, according to the modified example, based on the display state on the touch-panel liquid crystal display 402 of the information terminal 400 (such as smartphone or tablet terminal) owned by the user, that is, whether the number of characters that can be displayed in the character array direction is large or small depending on whether the information terminal 400 is used vertically or horizontally by the user, the main control section 403 can access the information providing center 200 by automatically switching between the access in the mobile user agent and the access in the PC user agent. That is, the main control section 403 of the information terminal 400 can appropriately issue the one information providing request signal or the another information providing request signal depending on the information display state (that is, whether the information terminal 400 is being used vertically or horizontally), and can acquire the content of the mobile-ready information or the content of the PC-ready information from the information providing center 200 to display the information on the touch-panel liquid crystal display 402.

With this configuration, also according to the modified example, in the same manner as in the above-mentioned embodiment, the information to be presented to the user can be presented with extremely satisfactory visibility ensured at all times without breaking the page layout due to the batter of a character, the distortion of an image, or the like. Accordingly, also according to the modified example, in the same manner as in the above-mentioned embodiment, the user can view the presented information with extreme ease.

The present invention to be carried out is not limited to the above-mentioned embodiment and the above-mentioned modified example, and various changes can be made without departing from an object of the present invention.

For example, in the above-mentioned embodiment or the above-mentioned modified example, the present invention is carried out so that the information presentation ECU 110 of the vehicle 100 or the main control section 403 of the information terminal 400 accesses the information providing center 200 by automatically switching between the access in the mobile user agent and the access in the PC user agent depending on the display state of the display 111 or the touch-panel liquid crystal display 402. Further, the present invention is carried out so that access contents are automatically changed depending on the display state in this manner, to thereby appropriately display (present) the information by reflecting the information display state of the display 111 or the touch-panel liquid crystal display 402 thereon.

In this case, the present invention can also be carried out so that the user of the vehicle 100 or the user of the information terminal 400 accesses the information providing center 200 by selectively switching between the access in the mobile user agent or the access in the PC user agent by himself/herself. This case is slightly complicated in that the user changes the access contents by himself/herself, but the information can be displayed (presented) by allowing the user to appropriately reflect his/her preference thereon.

Further, in the above-mentioned embodiment, it is assumed that the display 111 is shared with the navigation device 140. However, it should be understood that the present invention can be carried out so as to display other information, for example, battery information such as a charge-discharge status or a deterioration status when the vehicle 100 is, for example, an electric vehicle or a hybrid vehicle (including plug-in hybrid vehicle) that travels by using battery power. Even in this case, the same effects as those of the above-mentioned embodiment can be expected.

1. An information acquisition/presentation apparatus, comprising:
communication means for communicating to/from an external portion;
information acquisition means for acquiring information provided from the external portion through the communication means; and
information presentation means comprising a display for displaying the information acquired by the information acquisition means,
wherein the information presentation means switches the information to be displayed between the information in one display mode acquired by the information acquisition means and the information in another display mode different from the one display mode acquired by the information acquisition means depending on an information display state on the display.

2. An information acquisition/presentation apparatus according to claim 1, wherein the information presentation means issues one information providing request signal for requesting the external portion to provide the information to be displayed in the one display mode or another information providing request signal for requesting the external portion to provide the information to be displayed in the another display mode, which is different from the one information providing request signal, through the communication means depending on the information display state on the display, displays the information to be displayed in the one display mode, which has been acquired in correspondence with the one information providing request signal from the external portion by the information acquisition means, on the display, and displays the information to be displayed in the another display mode, which has been acquired in correspondence with the another information providing request signal from the external portion by the information acquisition means, on the display.

3. An information acquisition/presentation apparatus according to claim 1, wherein:
the one display mode comprises any one selected from the group consisting of:
a display mode in which a display area for displaying the information acquired from the external portion by the information acquisition means on the display is large;
a display mode in which a display pixel for displaying the information acquired from the external portion by the information acquisition means on the display is large; and
a display mode in which a number of characters that are displayable on the display in a character array direction of the information acquired from the external portion by the information acquisition means is large; and
the another display mode comprises any one selected from the group consisting of:
a display mode in which the display area for displaying the information acquired from the external portion by the information acquisition means on the display is small;
a display mode in which the display pixel for displaying the information acquired from the external portion by the information acquisition means on the display is small; and
a display mode in which the number of characters that are displayable on the display in the character array direction of the information acquired from the external portion by the information acquisition means is small.

4. An information acquisition/presentation apparatus according to claim 3, wherein the display mode of the another display mode in which the display area for displaying the information acquired from the external portion by the information acquisition means on the display is small comprises a display mode in which the information presentation means simultaneously displays a plurality of kinds of information on the display.

5. An information acquisition/presentation apparatus according to claim 4, wherein the plurality of kinds of information comprises at least navigation information for showing a route to a destination set by a user.

6. An information providing apparatus, comprising:
communication means for communicating to/from an external portion;
request acquisition means for acquiring a request relating to provision of information from the external portion through the communication means; and
information providing means for supplying and providing, through the communication means, the information corresponding to the request acquired by the request acquisition means, the information providing means comprising storage means for storing various kinds of information,
wherein the information providing means provides the external portion with the information to be displayed in one display mode or the information to be displayed in another display mode different from the one display mode.

7. An information providing apparatus according to claim 6, wherein:
the information providing means provides the external portion with the information corresponding to one information providing request signal for requesting to provide the information to be displayed in the one display mode, which is issued from the external portion based on an information display state on a display provided to the external portion, when the request acquisition means acquires the one information providing request signal; and
the information providing means provides the external portion with the information corresponding to another information providing request signal for requesting to provide the information to be displayed in the another display mode, which is different from the one information providing request signal and is issued from the external portion based on the information display state on the display provided to the external portion, when the request acquisition means acquires the another information providing request signal.

8. An information providing apparatus according to claim 6, wherein:
the one display mode comprises any one selected from the group consisting of:
a display mode in which a display area for displaying the information provided by the information providing means on the display provided to the external portion is large;
a display mode in which a display pixel for displaying the information provided by the information providing means on the display is large; and
a display mode in which a number of characters that are displayable on the display in a character array direction of the information provided by the information providing means is large; and
the another display mode comprises any one selected from the group consisting of:
a display mode in which the display area for displaying the information provided by the information providing means on the display provided to the external portion is small;
a display mode in which the display pixel for displaying the information provided by the information providing means on the display is small; and
a display mode in which the number of characters that are displayable on the display in the character array direction of the information provided by the providing acquisition means is small.

9. An information providing apparatus according to claim 8, wherein the display mode of the another display mode in which the display area for displaying the information provided by the information providing means on the display provided to the external portion is small comprises a display mode in which a plurality of kinds of information are simultaneously displayed on the display provided to the external portion.

10. An information providing apparatus according to claim 9, wherein the plurality of kinds of information comprises at least navigation information for showing a route to a destination set by a user of the external portion.

11. An information communication system, comprising an information providing apparatus for providing various kinds of information and an information acquisition/presentation apparatus for acquiring the various kinds of information provided from the information providing apparatus and presenting the various kinds of information, which communicate to/from each other, wherein:
the information acquisition/presentation apparatus issues one information providing request signal for requesting the information providing apparatus to provide the information to be displayed in one display mode or another information providing request signal for requesting the information providing apparatus to provide the information to be displayed in another display mode different from the one display mode, which is different from the one information providing request signal, depending on an information display state on a display for displaying the acquired information;
the information providing apparatus provides the information acquisition/presentation apparatus with the information to be displayed in the one display mode corresponding to the one information providing request signal when acquiring the one information providing request signal issued from the information acquisition/presentation apparatus, and provides the information acquisition/presentation apparatus with the information to be displayed in the another display mode corresponding to the another information providing request signal when acquiring the another information providing request signal issued from the information acquisition/presentation apparatus; and
the information acquisition/presentation apparatus displays the information to be displayed in the one display mode, which has been acquired in correspondence with the one information providing request signal from the information providing apparatus, on the display, and displays the information to be displayed in the another display mode, which has been acquired in correspondence with the another information providing request signal from the information providing apparatus, on the display.

12. An information communication system according to claim 11, wherein:
the one display mode comprises any one selected from the group consisting of:
a display mode in which a display area for displaying the information acquired from the information providing apparatus on the display of the information acquisition/presentation apparatus is large;
a display mode in which a display pixel for displaying the information acquired from the information providing apparatus on the display is large; and
a display mode in which a number of characters that are displayable on the display in a character array direction of the information acquired from the information providing apparatus is large; and
the another display mode comprises any one selected from the group consisting of:
a display mode in which the display area for displaying the information acquired from the information providing apparatus on the display of the information acquisition/presentation apparatus is small;
a display mode in which the display pixel for displaying the information acquired from the information providing apparatus on the display is small; and
a display mode in which the number of characters that are displayable on the display in the character array direction of the information acquired from the information providing apparatus is small.

13. An information communication system according to claim 12, wherein the display mode of the another display mode in which the display area for displaying the information acquired from the information providing apparatus on the display is small comprises a display mode in which the information acquisition/presentation apparatus simultaneously displays a plurality of kinds of information on the display.

14. An information communication system according to claim 13, wherein the plurality of kinds of information comprises at least navigation information for showing a route to a destination set by a user of the information acquisition/presentation apparatus.
